(19) United States
(12) Patent Application Publication
(10) Pub. No.: US 2008/0064620 A1
(43) Pub. Date: Mar. 13, 2008

(54) Mixtures Of Ammonionitrile Bleach Activators And Amino Acids

(76) Inventor: Gerd Reinhardt, Kelkheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/629,325

(22) PCT Filed: Jun. 8, 2005
(86) PCT No.: PCT/EP05/06134

§ 371 Date: Dec. 8, 2006

(30) Foreign Application Priority Data
Jun. 11, 2004 (DE) 10 2004 028 494.6

(51) Int. Cl. C11D 7/54

(52) U.S. Cl. 510/367

(57) ABSTRACT

Mixtures of ammonionitrile bleach activators and amino acids Mixtures of ammonionitrile bleach activators and amino acids which contain at least two nitrogen atoms are claimed, as is their use in bleaches and in washing and cleaning compositions. The presence of the amino acid lowers the color- and fiber-damaging action of the ammonionitriles.

Mixtures of ammonionitrile bleach activators and amino acids

The present invention relates to mixtures of ammonionitrile bleach activators and amino acids, and to their use together with peroxygen compounds in washing and cleaning compositions.

Inorganic peroxygen compounds, especially hydrogen peroxide and solid peroxygen compounds which dissolve in water with release of hydrogen peroxide, such as sodium perborate and sodium carbonate perhydrate, have been used for some time as oxidizing agents for disinfectant and bleaching purposes. The oxidative action of these substances in dilute solutions depends greatly upon the temperature; for example, sufficiently rapid bleaching of soiled textiles is achieved with H₂O₂ or perborate in alkaline-bleaching liquors only at temperatures above about 80° C.

At lower temperatures, the oxidative action of the inorganic peroxygen compounds can be improved by adding so-called bleach activators. For this purpose, numerous proposals have been developed in the past, in particular from the substance classes of the N— or O-acyl compounds, for example polyacylated alkylenediamines, in particular tetraacetylglycoluril, N-acylated hydantoins, hydrazides, triazoles, hydrotriazines, urazoles, carboxylic esters, especially sodium nonanoyloxybenzenesulfonate (NOBS), sodium isononanoyloxybenzenesulfonate (ISONOBS) and acylated sugar derivatives such as pentaacetyl glucose. Addition of these substances allows the bleaching action of aqueous peroxide solutions to be enhanced to such an extent that, even at temperatures around 60° C., essentially the same effects occur as with the peroxide solution alone at 95° C.

In the endeavor for energy-saving washing and bleaching processes, use temperatures significantly below 60° C., in particular below 45° C. down to cold water temperature, have gained significance in the last few years.

At these low temperatures, the action of the activator compounds known to date generally declines perceptibly. There has therefore been no lack of effort to develop more effective activators for this temperature range.

A particular class of bleach activators which are effective at low temperatures is that of ammonionitriles (“nitrile quats”). Compounds of this type and their use as bleach activators in bleaches are described in EP-A-0 303 520, EP-A-0 464 880, EP-A-0 458 396, EP-A-0 897 974 and EP-A-0 790 244.

However, in the presence of peroxygen compounds, these ammonionitriles do not just bleach stains such as tea or red wine stains, but can also interact with textile dyes, damaging the fibers and bleaching textile dyes. This damage can sometimes occur only after repeated bleaching. In order to ensure the long life of the textile material, such unwanted side reactions (dye and/or fiber damage) should be suppressed or at least minimized.

For this purpose, the literature has described a series of approaches. For example, EP 1 033 433 recommends singlet oxygen quenchers such as diazabicyclooctane (DABCO) or free-radical scavengers such as ascorbic acid diphenylamine. According to EP 0 510 331, protein hydrolyzates or conversion products with molecular weights of from 500 to 100 000 are used as bleach stabilizers. In this application, complexing agents such as EDTA and phosphonates are also mentioned for this end use.

U.S. Pat. No. 5,622,646 recommends the use of antioxidants such as BHT, BHA, TBHO, propyl gallate, ascorbic acid or mixtures thereof to reduce dye and fiber damage by bleach systems, especially metal complexes.

However, the approaches mentioned in the literature exhibit no significant effect on certain dyes. This is true in particular of metal-containing dyes with cyclic or acyclic, nitrogen-containing ligands.

The present invention has the aim of reducing dye and fiber damage caused by ammonionitrile bleach activators.

It has now been found that, surprisingly, addition of amino acids to the ammonionitrile bleach activators can suppress dye and fiber damage in the case of use of this substance class as bleach activators.

The invention provides mixtures of an ammonionitrile bleach activator and of an amino acid which contains at least two nitrogen atoms.

Useful ammonionitriles include in particular compounds of the formula (1) 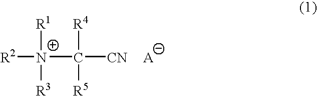
where R¹, R², R³ are the same or different and are each linear or branched C₁-C₂₄-alkyl groups, C₂-C₂₄-alkenyl groups or C₁-C₄-alkoxy-C₁-C₄-alkyl groups or benzyl, or where R¹ and R², together with the nitrogen atom to which they are bonded, form a ring which has from 4 to 6 carbon atoms and may be substituted by C₁-C₅-alkyl, C₁-C₅-alkoxy, C₁-C₅-alkanoyl, phenyl, amino, ammonium, cyano, cyanamino, chlorine or bromine, and, in addition to the nitrogen atom, instead of carbon atoms in the ring, may contain one or two oxygen atoms, an N—R⁶ group or an R³—N—R⁶ group, where R⁶ is hydrogen, C₁-C₅-alkyl, C₂-C₅-alkenyl, C₂-C₅-alkynyl, phenyl, C₇-C₉-arylalkyl, C₅-C₇-cycloalkyl, C₁-C₆-alkanoyl, cyanomethyl or cyano, R⁴ and R⁵ are each hydrogen, C₁-C₄-alkyl, C₁-C₄-alkenyl, C₁-C₄-alkoxy-C₁-C₄-alkyl, phenyl or C₁-C₃-alkylphenyl, preferably hydrogen, methyl or phenyl, where, in particular, R⁴ is hydrogen when R⁵ is not hydrogen, and A is an anion, for example chloride, bromide, iodide, fluoride, sulfate, hydrogensulfate, carbonate, hydrogencarbonate, phosphate, mono- and dihydrogenphosphate, pyrophosphate, metaphosphate, nitrate, methylsulfate, phosphonate, methylphosphonate, methanedisulfonate, methylsulfonate, ethanesulfonate, or an anion of the formulae R⁷SO₃^{⊖}, R⁷SO₄^{⊖} or R⁷COO^{⊖}, where R⁷ is C₁-C₂₀-alkyl, preferably C₁₀-C₁₈-alkyl, and additionally also C₁-C₁₈-alkylphenyl. Particular preference is given to toluene- and cumenesulfonate and to C₁₂-₁₈-alcoholsulfate as the anion.

Particularly preferred ammonionitriles are compounds of the formula (2) 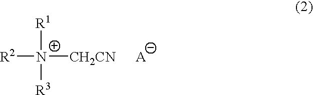
where R¹, R² and R³ are each a linear or branched alkyl group having from 1 to 24 carbon atoms, an alkenyl group having from 2 to 24 carbon atoms or benzyl, and A is any charge-balancing ion, for example chloride, bromide, iodide, fluoride, sulfate, hydrogensulfate, carbonate, hydrogencarbonate, phosphate, mono- and dihydrogenphosphate, pyrophosphate, metaphosphate, nitrate, methylsulfate, phosphonate, methylphosphonate, methanedisulfonate, methylsulfonate, ethanesulfonate, or an anion of the formulae R⁷SO₃^{⊖}, R⁷SO₄^{⊖} or R⁷COO^{⊖}, where R⁷ is as defined above. Particular preference is given to toluene- and cumenesulfonate as the anion.

Preference is also given to ammonionitriles of the formula (3) 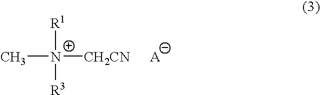
where R¹ and R³ are each C₁-C₈-alkyl and A is toluenesulfonate or cumenesulfonate.

Particular preference is given to the use of compounds of the formula 2 in which R¹, R² and R³ are each a methyl group. The charge-balancing anion may be any anion, but preferably toluenesulfonate or cumenesulfonate.

Preference is further given to compounds of the formula 2 in which R¹ is a methyl group, R² and R³ are each either a butyl group or hexyl group (dibutylmethylammonioacetonitrile or dihexylmethylammonioacetonitrile) or compounds of the formula 2 in which R¹ and R² are each a methyl group and R³is an octyl group (dimethyloctylammonioacetonitrile).

Also of particular interest are diquats of the general structure (4) 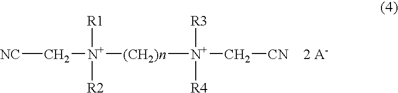
where n=2, 3 or 4 and

R¹, R², R³, R⁴ are each a linear or branched alkyl group having from 1 to 24 carbon atoms, an alkenyl group having from 2 to 24 carbon atoms or benzyl, and A is any charge-balancing ion. Preference is given here to compounds where R¹=R²=R³=R⁴=methyl or ethyl, n=2 or 3 and A are tosylate groups.

Ammonionitriles of the formula 1 -4 feature particularly good bleaching capacity in the presence of a bleach at low temperatures in the range from 10° C. to 50° C.

Preferred amino acids are histidine, arginine, lysine and tryptophan; particular preference is given to histidine. The amino acids may be used in the form of the free acid or as salts thereof, for example as hydrochlorides. The inventive mixtures may comprise a single ammonionitrile or mixtures of different ammonionitriles. The same applies to the amino acids.

The use concentration of the amino acid is 0.1-15% by weight based on the bleach activator used, but preferably 0.5-5.0% by weight. The amino acids may be added in solid or liquid form or as aqueous solution. In a preferred embodiment, the ammonionitrile is mixed with the amino acid and cogranulated. The production of nitrile quat granules is described, inter alia, in DE 197 40 669, DE 197 40 671, WO 2002/012426 or WO 2002/026927.

The inventive mixtures are used in washing and cleaning compositions, especially in textile laundry and in cleaning compositions for hard surfaces, especially for dishware, and in solutions for bleaching colored stains. This is done in the presence of hydrogen peroxide, hydrogen peroxide-releasing compounds or of a peroxygen compound.

Useful peroxygen compounds are primarily alkali metal perborate mono- or tetrahydrate and/or alkali metal percarbonates, sodium being the preferred alkali metal. In addition, it is also possible to use alkali metal peroxosulfates or ammonium peroxosulfates, for example potassium peroxomonosulfate (in industry: Caroat® or Oxone®). The concentration of the inorganic oxidizing agents in the overall formulation of the washing and cleaning compositions is 5-90%, preferably 10-70%.

In addition or alternatively, oxidizing agents on an organic basis are also useful. These include all known peroxycarboxylic acids, for example monoperoxyphthalic acid, dodecanediperoxy acid, phthalimidoperoxy-carboxylic acids such as PAP and related systems, or the amido peracids mentioned in EP-A 170 386.

The term “bleaching” here encompasses both the bleaching of soil present on the textile surface and the bleaching of soil detached from the textile surface and present in the wash liquor.

The washing and cleaning compositions, which may be present as granules, pulverulent or tableted solids, as other moldings, homogeneous solutions or suspensions, may, apart from the mixture of ammonionitrile bleach activator and amino acid, in principle comprise all known ingredients customary in such compositions. The compositions may in particular be builder substances, surfactants, peroxygen compounds, additional peroxygen activators or organic peracids, water-miscible organic solvents, sequestering agents, enzymes and specialty additives with color- or fiber-care action. Further assistants such as electrolytes, pH regulators, silver corrosion inhibitors, foam regulators and dyes and fragrances are possible.

Suitable organic and inorganic builders include neutral or especially alkaline salts which are capable of precipitating out calcium ions or of binding them in complex form. Suitable and especially ecologically satisfactory builder substances, such as finely crystalline, synthetic water-containing zeolites of the NaA type, which have a calcium-binding capacity in the range from 100 to 200 mg of CaO/g, are used with preference. In addition to zeolite, it is also possible with preference to use sheet silicates and amorphous silicates. Likewise suitable are alkali metal phosphates which may be present in the form of their alkaline, neutral or acidic sodium or potassium salts. Examples thereof are trisodium phosphate, tetrasodium diphosphate, disodium dihydrogendiphosphate, pentasodium triphosphate, so-called sodium hexametaphosphate, oligomeric trisodium phosphate with degrees of oligomerization of from 5 to 1000, in particular from 5 to 50, and mixtures of sodium and potassium salts.

Usable organic builder substances are, for example, the carboxylic acids, which are preferably used in the form of their sodium salts, such as citric acid, nitriloacetate (NTA) and ethylenediaminetetraacetic acid, provided that such a use is not objectionable for ecological reasons, and phosphonic and polyphosphonic acids. Analogously thereto, it is also possible to use polymeric carboxylates and salts thereof. These include, for example, the salts of homopolymeric or copolymeric polyacrylates, polymethacrylates and in particular copolymers of acrylic acid with maleic acid, preferably those composed of from 50% to 10% maleic acid, and polyaspartic acid and also polyvinylpyrrolidone and urethanes. The relative molecular mass of the homopolymers is generally between 1000 and 100 000, that of the copolymers between 2000 and 200 000, preferably from 50 000 to 120 000, based on the free acid; in particular, also suitable are water-soluble polyacrylates which are crosslinked, for example, with about 1% of a polyallyl ether of subrose and which have a relative molecular mass above one million. Examples thereof are the polymers obtainable under the name Carbopol 940 and 941.

The washing and cleaning compositions may comprise one or more surfactants, useful surfactants being in particular anionic surfactants, nonionic surfactants and mixtures thereof, but also cationic, zwitterionic and amphoteric surfactants. Such surfactants are present in inventive washing compositions in proportions of preferably from 1 to 50% by weight, in particular from 3 to 30% by weight, whereas cleaning compositions for hard surfaces normally contain smaller proportions, i.e. amounts of up to 20% by weight, in particular up to 10% by weight and preferably in the range from 0.5 to 5% by weight. In cleaning compositions for use in machine dishwashing processes, low-foaming compounds are normally used.

In addition to the ammonionitriles used in accordance with the invention, it is additionally possible to use further conventional bleach activators, i.e. compounds which, under perhydrolysis conditions, release peroxocarboxylic acids. Suitable compounds are the customary bleach activators which O— and/or N-acyl groups. Preference is given to polyacylated alkylenediamines, especially tetraacetylethylenediamine (TAED), acylated glycolurils, especially tetraacetylglycoluril (TAGU), acylated triazine derivatives, especially 1,5-diacetyl-2,4-dioxohexahydro-1,3,5-triazine (DADHT), acylated phenolsulfonates, especially nonanoyl- or isononanoyloxybenzenesulfonate (NOBS and ISONOBS) or their amido derivatives as described, for example, in EP 170 386, acylated polyhydric alcohols, especially triacetin, ethylene glycol diacetate and 2,5-diacetoxy-2,5-dihydrofuran, and also acetylated sorbitol and mannitol, and acylated sugar derivatives, especially pentaacetylglucose (PAG), pentaacetylfructose, tetraacetylxylose and octaacetyllactose, and also acetylated, optionally N-alkylated glucamine and gluconolactone. Also suitable for this end use are open-chain or cyclic nitrile quats, as known from EP-A 303 520 and WO 98/23602. The combinations of conventional bleach activators known from DE 44 43 177 can also be used.

The enzymes include proteases, amylases, pullulanases, cellulases, cutinases and/or lipases, for example proteases such as BLAP®, Optimase®, Opticlean®, Maxacal®, Maxapem®, Durazym®, Purafect® OxP, Esperase® and/or Savinase®, amylases such as Termamy®, Amylase-LT, Maxamyl®, Duramyl®, Purafectel OxAm, cellulases such as Celluzyme®, Carezyme®, K-AC® and/or the cellulases and/or lipases known from the International patent applications WO 96/34108 and WO 96/34092 such as Lipolase®, Lipomax®, Lumafast® and/or Lipozym®. The enzymes used may be adsorbed on carrier substances and/or embedded into coating substances in order to protect them against premature inactivation. They are present in inventive washing and cleaning compositions preferably in amounts of up to 10% by weight, in particular from 0.05 to 5% by weight, particular preference being given to using enzymes stabilized against oxidative degradation.

The washing and cleaning compositions or bleaches are preferably present in the form of pulverulent, granular or tableted preparations which can be prepared in a manner known per se, for example by mixing, granulation, roller compaction and/or by spray-drying of the thermally stressable components and admixing of the more sensitive components, which include in particular enzymes, bleaches and the bleach catalyst. Inventive compositions in the form of aqueous solutions or those comprising other customary solvents are prepared particularly advantageously by simply mixing the ingredients, which may be introduced into an automatic mixer in substance or as a solution.

To prepare particulate compositions with elevated bulk density, especially in the range from 650 g/l to 950 g/l, a process which comprises an extrusion step and is known from EP 0 486 592 is preferred. A further preferred preparation with the aid of a granulation process is described in EP 0 642 576. The preparation of inventive compositions in the form of nondusting, storage-stable, free-flowing powders and/or granules with high bulk densities in the range from 800 to 1000 g/l can also be effected by, in a first process stage, mixing the builder components with at least a fraction of liquid mixture components while increasing the bulk density of this premixture and then, if desired after an intermediate drying, combining the further constituents of the composition, including the bleach catalyst, with the premixture obtained in this way.

To prepare inventive compositions in tablet form, the procedure is preferably to mix all constituents together in a mixer and to compress the mixture by means of conventional tableting presses, for example eccentric presses or rotary presses, with pressures in the range from 200·10⁵ Pa to 1500·10⁵ Pa. In this way, fracture-resistant tablets which are nevertheless sufficiently rapidly soluble under use conditions and have flexural strengths of normally above 150 N are obtained without any problem. A tablet produced in this way preferably has a weight of from 1-5 g to 40 g, in particular from 20 g to 30 g, at a diameter of from 3-5 mm to 40 mm.

### COMPARATIVE EXAMPLE 1

### Color Damage by Bleach Systems

The wash tests were carried out in a Linitest unit (from Heräus). The wash time was 30 min, water hardness 18° GH. The bleach test fabric used was Reactive Blue 235 on cotton.

A wash liquor was prepared from 10 g/l of a bleach-free base detergent (WMP, WFK, Krefeld), 12 g/l of sodium percarbonate (from Degussa) and 1.75 g/l of trimethylammonioacetonitrile tosylate, and the bleach test fabric was washed 5 times at 40° C. Subsequently, the color damage was determined with an Elrepho instrument as the difference in reflectance from the unwashed dyed fabric.

After the 5th wash, the difference in reflectance was 14.8 reflectance units; the dye was significantly damaged.

### EXAMPLE 1

Comparative test 1 was repeated, except that different amounts of the amino acid histidine were now added per wash cycle. After the 5th wash cycle, the following reflectance values were obtained:

| Amount of histidine used | |
|---|---|
| (based on bleach activator) | Delta E |
| 0.5% | 10.2 |
| 3.0% | 5.0 |
| 6.0% | 4.6 |
| 15% | 2.9 |

The bleaching results show that the inventive addition of the amino acid histidine to the bleaching process significantly suppresses the color damage on this dye. For instance, at use concentrations of 0.5% of amino acid, the color damage is reduced by approx. 30%, and, in the case of additions of 3%, by over 60%.

### COMPARATIVE EXAMPLE 2

### Color Damage by Bleach Systems

Comparative example 1 was repeated, except that Reactive Violet 5 on cotton served as the test fabric. After the 5th wash, the difference in reflectance was 48.6 reflectance units; the dye was significantly damaged.

### EXAMPLE 2

Comparative test 2 was repeated, except that different amounts of the amino acid histidine were now added per wash cycle. After the 5th wash cycle, the following reflectance values were obtained:

| Amount of histidine used | |
|---|---|
| (based on bleach activator) | Delta E |
| 0.5% | 47.0 |
| 3.0% | 41.2 |
| 6.0% | 37.3 |
| 15% | 28.8 |

The bleaching results show that the inventive addition of the amino acid histidine to the bleaching process significantly suppresses the color damage on this dye.

### COMPARATIVE EXAMPLE 3

### Color Damage by Bleach Systems

Comparative example 1 was repeated, except that 2.0 g/l of dihexylmethylammonioacetonitrile cumenesulfonate were used instead of 1.75 g/l of trimethylammonioacetonitrile tosylate. After the 5th wash, the difference in reflectance was 11.9 reflectance units; the dye was significantly damaged.

### EXAMPLE 3

Comparative test 3 was repeated, except that different amounts of the amino acid histidine were now added per wash cycle. After the 5th wash cycle, the following reflectance values were obtained:

| Amount of histidine used | |
|---|---|
| (based on bleach activator) | Delta E |
| 0.5% | 9.4 |
| 3.0% | 4.4 |
| 6.0% | 2.9 |
| 15% | 1.8 |

The bleaching results show that the inventive addition of the amino acid histidine to the bleaching process significantly suppresses the color damage on this dye. For instance, at use concentrations of 0.5% of amino acid, the color damage is reduced by approx. 20%, and, in the case of additions of 3%, by over 75%.

### EXAMPLE 4

Cogranule consisting of nitrile quat and histidine.

According to example 1 in DE 19740671, 10 kg of a mixture of 90% by weight of trimethylammonioacetonitrile tosylate, 2% by weight of histidine and 8% by weight of bentonite are mixed intensively in a Lödige mixer with a rotational speed of 70 rpm for 10 min. This mixture is subsequently compressed with a pressing force of 50-60 kN on a roll compactor (from Bepex) and subsequently ground in two stages and sieved.

5.5 kg of a homogeneous granule having a particle size of 200-1600 μm are obtained. The coarse material is subsequently ground and sieved again.

The granule thus produced has distinctly less color damage on Reactive Blue 235 than a granule according to DE 19740671 which does not comprise the inventive histidine addition.

What is claimed is:

1. A mixture consisting essentially of an ammonionitrile bleach activator and of an amino acid which contains at least two nitrogen atoms.

2. The mixture as claimed in claim 1, wherein the ammonionitrile bleach activator satisfies the formula (1) 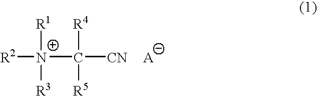
where R¹, R², R³ are the same or different and are each linear or branched C₁-C₂₄-alkyl groups, C₂-C₂₄-alkenyl groups or C₁-C₄-alkoxy-C₁-C₄-alkyl groups or benzyl, or where R¹ and R², together with the nitrogen atom to which they are bonded, form a ring which has from 4 to 6 carbon atoms and may be substituted by C₁-C₅-alkyl, C₁-C₅-alkoxy, C₁-C₅-alkanoyl, phenyl, amino, ammonium, cyano, cyanamino, chlorine or bromine, and, in addition to the nitrogen atom, instead of carbon atoms in the ring, may contain one or two oxygen atoms, an N—R⁶ group or an R³—N—R⁶ group, where R⁶ is hydrogen, C₁-C₅-alkyl, C₂-C₅-alkenyl, C₂-C₅-alkynyl, phenyl, C₇-C₉-arylalkyl, C₅-C₇-cycloalkyl, C₁-C₆-alkanoyl, cyanomethyl or cyano, R⁴ and R⁵ are each hydrogen, C0-C₄-alkyl, C₁-C₄-alkenyl, C₁-C₄-alkoxy-C₁-C₄-alkyl, phenyl or C₁-C₃-alkylphenyl, and A is an anion.

3. The mixture as claimed in claim 1, wherein the ammonionitrile bleach activator satisfies the formula (2) 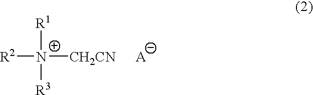
where R¹, R² and R³ are each a linear or branched alkyl group having from 1 to 24 carbon atoms, an alkenyl group having from 2 to 24 carbon atoms or benzyl, and A is chloride, bromide, iodide, fluoride, sulfate, hydrogensulfate, carbonate, hydrogencarbonate, phosphate, mono- and dihydrogenphosphate, pyrophosphate, metaphosphate, nitrate, methylsulfate, phosphonate, methylphosphonate, methanedisulfonate, or an anion of the formulae R⁷SO₃^{⊖}, R⁷SO₄^{⊖} or R⁷COO^{⊖}, where R⁷ is C₁-C₂₀-alkyl or C₁-C₄-alkylphenyl.

4. The mixture as claimed in claim 1, wherein the ammonionitrile bleach activator satisfies the formula (3) 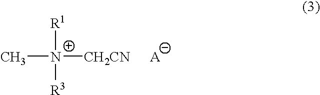
where R¹ and R³ are each C₁-C₈-alkyl and A is toluenesulfonate or cumenesulfonate.

5. The mixture as claimed in claim 1, wherein the ammonionitrile bleach activator satisfies the formula (4) 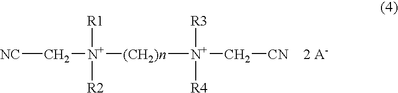
where n=2, 3 or 4 and
R¹, R², R³, R⁴ are each a linear or branched alkyl group having from 1 to 24 carbon atoms, an alkenyl group having from 2 to 24 carbon atoms or benzyl, and A is any charge-balancing ion.

6. The mixture as claimed in claim 1, wherein they comprise, as the amino acid, histidine, arginine, lysine or tryptophan.

7. The mixture as claimed in claim 1, wherein they contain from 0.1 to 15% by weight of the amino acid based on the bleach activator.

8. A bleach comprising a mixture as claimed in claim 1.

9. A washing and cleaning composition comprising a mixture as claimed in claim 1.
